(19) United States
(12) Patent Application Publication
(10) Pub. No.: US 2025/0086083 A1
(43) Pub. Date: Mar. 13, 2025

(54) SYSTEMS AND METHODS FOR DETECTION OF ANOMALOUS EVENTS

(71) Applicant: The Toronto-Dominion Bank, Toronto (CA)

(72) Inventors: Tarundeep Dhot, Toronto (CA); Mohsen Raza, Toronto (CA); Katarzyna Dorota Wyroslak, Limoges (CA); Bote Jiang, Toronto (CA); Abdullah Al Hamour Al Jarad, London (CA); Thibakar Sanderalingam, Markham (CA)

(21) Appl. No.: 18/466,096

(22) Filed: Sep. 13, 2023

(51) Int. Cl. G06F 11/32

(52) U.S. Cl. CPC G06F 11/328

(57) ABSTRACT

Systems and methods for processing high volumes of event data to produce a plurality of metrics and determining threshold baselines at which to alert to anomalous event activity. Raw event data is processed into staging tables comprises of the plurality of metrics. Baselines are determined based on one or more past instances of the time segment in a given cycle. Monitoring interfaces are also provided to aid rapid identification of anomalous activity.

### TECHNICAL FIELD

The disclosed exemplary embodiments relate to computer-implemented systems and methods for processing data and, in particular, to systems and methods for the generating real-time alerts based on large volumes of data.

### BACKGROUND

In many computing environments, systems exist to log and monitor events. In many instances, such systems will handle a large volume of events that can total in the millions or even billions of events daily. Depending on the type of events, there may be a need to monitor the events—continuously and in real-time—at a variety of granularity levels to identify anomalous activity, which can be due to malicious actors, or could be a sign of a system that is not functioning as expected.

However, when there is a large volume of activity, monitoring can be difficult. Conventionally, some enterprises will engage teams of employees to generate and run specific queries of the event activity, which can generate reports. These queries and reports can be run periodically, e.g., hourly, and then saved in a central location or database. In some cases, the reports are saved as spreadsheets, which can be configured to generate visualizations of the transaction data. However, this approach still requires periodic and, more importantly, manual monitoring of the reports. Moreover, this approach requires employees to possess the necessary skill and experience to identify anomalous behaviour, which may not be immediately evident to the untrained eye. In many cases, even experienced employees may have difficulty recognizing subtle changes in event activity patterns. Examples have been documented where such manual monitoring failed to recognize anomalous activity in a timely fashion.

Tools exist to visualize data and even provide alerts in the cases of anomalies. However, examples of such visualization software, such as Tableau™, re not suited for monitoring high volumes of transaction data, which can be measured in the hundreds of thousands or millions of transactions daily, as they can quickly run into computing resource issues such as a lack of memory or processing power. Moreover, in some contexts, it may not be possible to share the raw event data, e.g., due to the presence of sensitive information such as personally-identifiable information, with the result that some systems may be precluded from exporting transaction data to software such as Tableau™.

### SUMMARY

The following summary is intended to introduce the reader to various aspects of the detailed description, but not to define or delimit any invention.

In one general aspect, a system may include a plurality of data sources having at least a first data source and a second data source. The system may also include a first microservice processor configured to process the first data source to form a first plurality of metrics for a time segment. The system may furthermore include a second microservice processor configured to process the second data source to form a second plurality of metrics for the time segment. The system may in addition include a monitoring processor configured to: obtain the first plurality of metrics for the time segment from the first microservice processor; obtain the second plurality of metrics for the time segment from the second microservice processor; update a staging table with the first and second plurality of metrics; compute a first threshold baseline for the first plurality of metrics based on one or more past instances of the time segment; compute a second threshold baseline for the second plurality of metrics based on the one or more past instances of the time segment; display a first indication of the first plurality of metrics in a dashboard, where the first indication is indicative that the first plurality of metrics exceeds the first threshold baseline; and display a second indication of the second plurality of metrics in the dashboard. Other embodiments of this aspect include corresponding computer systems, apparatus, and computer programs recorded on one or more computer storage devices, each configured to perform the actions of the methods.

Implementations may include one or more of the following features. A system where the second indication is indicative that second first plurality of metrics exceeds the second threshold baseline, and where the second indication is displayed proximally with the first indication. A system where the first and second indication may include a connection indicator between the first and second indication. A system may include: at least one additional microservice processor, each microservice processor configured to process a respective data source to form a respective plurality of metrics for the time segment, where the monitoring processor is further configured to, for each respective one of the at least one additional microservice processor: obtain the respective plurality of metrics for the time segment; update the staging table with the respective plurality of metrics; compute a respective threshold baseline for the respective plurality of metrics based on the one or more past instances of the time segment; and display a respective indication of the respective plurality of metrics in the dashboard. A system may include an agent processor, the agent processor configured to: monitor the dashboard interface for the first indication; when the first indication is indicative that the first plurality of metrics exceeds the first threshold baseline, generate a natural language summary of the first indication; and transmit the natural language summary of the first indication to a message service. A system where the agent processor is further configured to monitor the message service for a command instruction and, in response to receipt of the command instruction, interact with the dashboard interface. A system where the interaction with the dashboard interface may include retrieving additional detail from the dashboard interface regarding the first indication. A system where the first microservice processor processes the first data source in a pipelined process for the time segment by querying the first data source for data associated with the time segment. Implementations of the described techniques may include hardware, a method or process, or a computer tangible medium.

In one general aspect, a method may include obtaining a first plurality of metrics for a time segment. The method may also include obtaining a second plurality of metrics for the time segment. The method may furthermore include updating a staging table with the first and second plurality of metrics. The method may in addition include computing a first threshold baseline for the first plurality of metrics based on one or more past instances of the time segment. The method may moreover include computing a second threshold baseline for the second plurality of metrics based on the one or more past instances of the time segment. The method may also include displaying a first indication of the first plurality of metrics in a dashboard, where the first indication is indicative that the first plurality of metrics exceeds the first threshold baseline. The method may furthermore include displaying a second indication of the second plurality of metrics in the dashboard. Other embodiments of this aspect include corresponding computer systems, apparatus, and computer programs recorded on one or more computer storage devices, each configured to perform the actions of the methods.

Implementations may include one or more of the following features. A method where the first plurality of metrics is obtained from a first microservice processor configured to process the first data source to form the first plurality of metrics for the time segment. A method where the second plurality of metrics is obtained from a second microservice processor configured to process the second data source to form the second plurality of metrics for the time segment. A method where the second indication is indicative that second first plurality of metrics exceeds the second threshold baseline, and where the second indication is displayed proximally with the first indication. A method where the first and second indication may include a connection indicator between the first and second indication. A method may include at least one additional microservice processor processing a respective data source to form a respective plurality of metrics for the time segment. A method may include the monitoring processor, for each respective one of the at least one additional microservice processor: obtaining the respective plurality of metrics for the time segment; updating the staging table with the respective plurality of metrics; computing a respective threshold baseline for the respective plurality of metrics based on the one or more past instances of the time segment; and displaying a respective indication of the respective plurality of metrics in the dashboard. A method may include an agent processor: monitoring the dashboard interface for the first indication; when the first indication is indicative that the first plurality of metrics exceeds the first threshold baseline, generating a natural language summary of the first indication; and transmitting the natural language summary of the first indication to a message service. A method may include the agent processor monitoring the message service for a command instruction and, in response to receipt of the command instruction, interacting with the dashboard interface. A method where the interaction with the dashboard interface may include retrieving additional detail from the dashboard interface regarding the first indication. A method where the first microservice processor processes the first data source in a pipelined process for the time segment by querying the first data source for data associated with the time segment. Implementations of the described techniques may include hardware, a method or process, or a computer tangible medium.

According to some aspects, the present disclosure provides a non-transitory computer-readable medium storing computer-executable instructions. The computer-executable instructions, when executed, configure a processor to perform any of the methods described herein.

### BRIEF DESCRIPTION OF THE DRAWINGS

The drawings included herewith are for illustrating various examples of articles, methods, and systems of the present specification and are not intended to limit the scope of what is taught in any way. In the drawings:

FIG. 1 is a schematic block diagram of an exemplary system for identifying anomalies in event activity data in accordance with at least some embodiments;

FIG. 2 is a block diagram of a computer in accordance with at least some embodiments;

FIGS. 3A and 3B illustrate a flowchart diagram of an example method for identifying anomalies in event activity data in accordance with at least some embodiments; and

FIGS. 4A and 4B illustrate example dashboard displays in accordance with at least some embodiments.

### DETAILED DESCRIPTION

The described embodiments generally provide systems and methods for real-time monitoring of event activity to identify anomalies due to, e.g., faults or malicious activity. In contrast to existing conventional tools that require manual analysis and rely on end users to pro-actively monitor reports on a timely basis, the described embodiments are automated and capable of handline millions of events daily. In at least some cases, raw event data is first processed and aggregated into staging tables, which segregate data into hourly segments. Those hourly segments can then be processed by rules-based, automated visualization and alerting tools. To prevent false positives, the automation tool can perform historical baselining and thresholding specific to time of day and day of week. Accordingly, the provided systems and methods are able to process event data, aggregate periodic statistics, apply one or more rules to the aggregated statistics to identify anomalous activity and, optionally, send notifications to users.

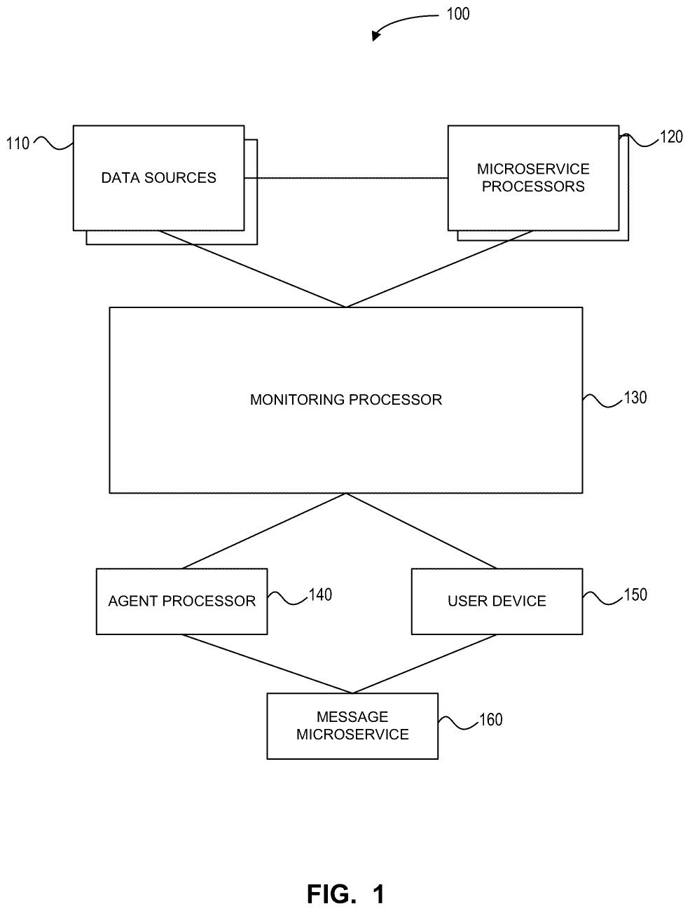

Referring now to FIG. 1, there is illustrated a block diagram of an example computing system, in accordance with at least some embodiments. Computing system 100 has one or more data sources 110, one or more microservice processor 120, at least one monitoring processor 130, at least one agent processor 140, a user device 150 and a message microservice 160.

Each of the data sources 110 provides respective raw data. For example, a first data source may offer a first type of event data, while a second data source may offer a second type of event data.

A variety of different events can be monitored and provided in the raw data. For example, the events may relate to user account activity, such as new account openings, account changes, password resets, etc. Other types of events may relate to user actions, including electronic transactions such as sent or received messages, credit card transactions, electronic fund transfers, deposit/withdrawal transactions, and the like. In other contexts, the events can relate to activity received from other systems including third-party systems. For example, some data sources may be configured to provide data relating to suspicious or malicious activity. In some cases, source data may include performance data for critical systems, such as fraud activity databases, client notification systems and self-cure systems, and vendor outage data. In some cases, incoming data can also include call center service activity, e.g., to identify unusually high or low call volumes.

Generally, the raw data from data sources produces a relatively high volume of data, which can number, e.g., in the millions of events per day or higher. Accordingly, one or more microservice processors may be configured to monitor and process each feed to produce metrics for given time segments.

For example, processing the raw feed may be performed in pipelined processes corresponding to each time segment that query for data from the raw feed and update one or more staging tables with aggregate data comprised of metrics based on the raw event data over a desired time segment (e.g., hourly statistics). This aggregation process can therefore generate a plurality of metrics that can be used as input for rules-based monitoring.

In at least some embodiments, a plurality of microservice processors 120 may be assigned to monitor and process each of a plurality of data sources. In other cases, microservice processors 120 may be pooled, such that there is not a one-to-one correspondence between data sources and microservice processors. Still, as an example, a first microservice processor can be configured to process a first data source to form a first plurality of metrics for a time segment, while a second microservice processor can be configured to process a second data source to form a second plurality of metrics for the same time segment, and so forth.

A monitoring processor 130 is provided that can obtain the plurality of metrics for each time segment from the respective microservice processors and update staging tables using the plurality of metrics.

By way of non-limiting example, metrics may include volumes of: purchases, account deposits, address maintenances, balance inquiries, card activations, card requests, cash advances, bill payments, card verifications, non-monetary transactions, payments, phone number changes, PIN changes, purchase returns and electronic funds transfers and other cash-like transactions.

Other metrics may include connectivity levels for other systems, data latency, call center volumes, answer speed, queue length, average handle time, etc.

As noted, these metrics may be stored in the one or more staging tables and associated with a specific time period (e.g., hourly). In this way, the volume of data is significantly reduced from the raw transaction data. At the same time, the staging tables can be designed to limit or eliminate the amount of personally-identifiable data they contain.

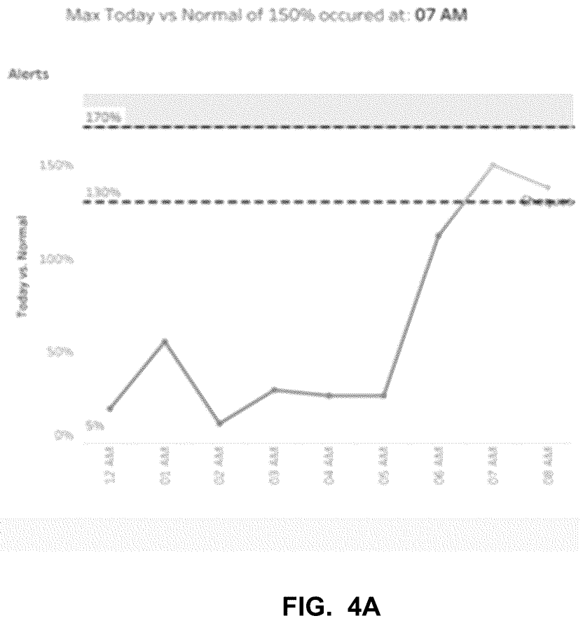

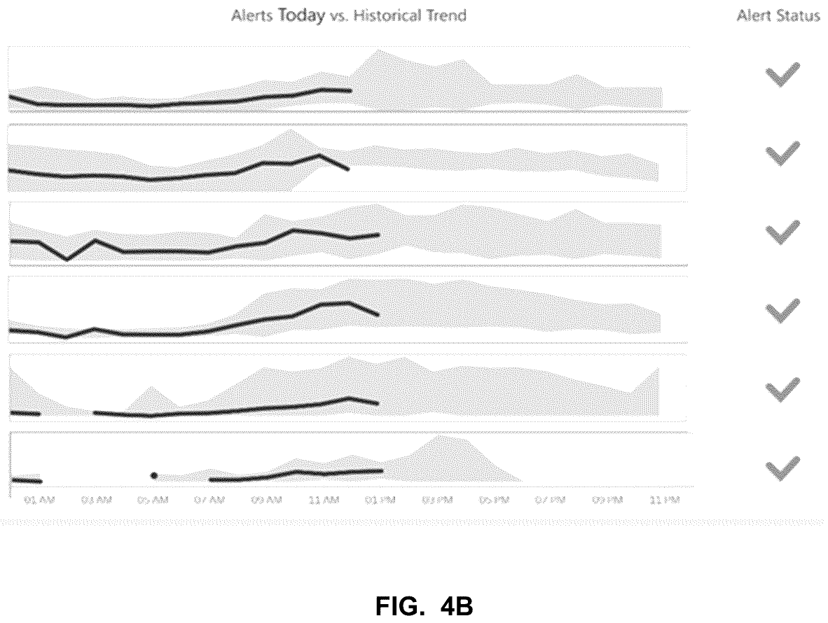

Once the metrics are created and stored in staging tables, the monitoring processor 130 can also compute respective threshold baselines for each the plurality of metrics based on one or more past instances of the time segment, and generate indications of each of the plurality of metrics for display in a dashboard, particularly where one or more indication indicates that one or more of the metrics exceeds its respective baseline. Baselines may be individually configurable by a user of the dashboard. For example, baselines for each metric may be set at 110%, 120%, 130%, etc., of historical activity. Furthermore, there may be multiple thresholds. For example, a first warning baseline may be set at 130% of historical activity, and a second critical baseline may be set at 170% of historical activity. FIG. 4A illustrates an example dashboard display of one metric which has a first threshold baseline of 130%, which has been exceeded in a given time segment, but is still less than a second threshold baselines of 170%. The indication that the first threshold baseline has been exceeded is provided by displaying a line chart of volume level, coupled with dotted threshold lines.

This historical baselining and comparison can facilitate identifying anomalous activity. Specifically, rather than set predetermined thresholds for event activity which could lead to both false positives and false negatives due to natural variations in activity over time, the system dynamically identifies a historical baseline for every time segment in a given cycle or window.

FIG. 4B illustrates an example dashboard display for several different metrics, showing dynamic lower and upper threshold baselines (in gray shading), coupled with a line chart of volumes for a number of different metrics. A summary status indicator (e.g., a checkmark) is also displayed in proximity to each line chart. In the event that one of the metrics exceeds a baseline, the status indicator may change, e.g., to an exclamation point.

For example, in some implementations, the historical baseline is based on comparable time of week and hour of day over a rolling window. For example, for a given time period of “Monday at 9:00 am” the system identifies weekly and hourly cyclic activity levels for each aggregated metric, e.g., at the same time of week and hour of day in the past N number of weeks (e.g., where N=4, 12, 52, etc.). The system then takes the average of the activity in the past weeks, and sets a threshold based on the average and a buffer. The buffer is configurable for each metric, and can be a percentage or variable value (e.g., three standard deviations). When the current activity rises above (or below) the threshold, an alert can be triggered and a notification can be sent to one or more user devices 150 (which alerts are also configurable).

In other implementations, the comparison period can be configured to be based on other factors, such as time of the month, time of quarter, time of year, etc. In some cases, exceptions can be configured to account for known variations, such as statutory holidays that could lead to lower event volumes.

A summary view may also be provided in a dashboard interface, which provides an “at-a-glance” view of a large number of different metrics, coupled with simple status indicators indicating whether volumes are within expected levels (e.g., status indicator of a dash), exceeding expected levels (e.g., status indicator of an up arrow), below expected levels (down arrow), or missing (e.g., no status indicator or some other indication). In some cases, a percentage indicator (e.g., in a “gauge” style graphic) may be provided to show levels. Likewise, numerical indicators of volumes may also be provided, together with averages, medians or totals for context. In some cases, bar chart displays may also be provided, to show relative volumes of certain activity over time.

As and when additional data sources are added or updated, additional microservice processors 120 can be configured to process the respective data sources to form additional metrics for the time segments. In such cases, the monitoring processor 130 can again obtain the plurality of metrics for each time segment from the respective microservice processors, update staging tables using the metrics, compute respective threshold baselines for each the plurality of metrics based on one or more past instances of the time segment, and generate indications of each of the plurality of metrics for display in a dashboard, particularly where one or more indication indicates that one or more of the metrics exceeds its respective baseline.

In some embodiments, an agent processor 140 may be provided, which can be configured to monitor for the indications of a metric exceeding its baseline, e.g., in a dashboard interface. When the agent processor 140 detects that a baseline has been exceeded, it may generate a natural language summary of the relevant indication and transmit the natural language summary to a message microservice 160, which can provide a notification to a user device 150. The agent processor 140 can interact with users over messaging channels, such as Microsoft Teams™, PowerAutomate™ or Slack™. The message service, or “bot”, monitors the messaging channels and can accept commands for execution in the dashboard interface. The message service can be triggered to send notifications when a threshold is reached, or it can also periodically, or on demand, monitor a dashboard and summarize its state in the messaging channel, for the benefit of users who may not have access to a dashboard display. The system can be modular and extensible such that additional rules can be configured to monitor one or more metrics and generate alerts, as necessary. Each module is independent and the system operates using the microservices architecture.

In some cases, the agent processor 140 can be further configured to monitor the message service for a command instruction and, in response to receipt of the command instruction, interact with the dashboard interface based on the command instruction. For example, the command instruction may cause the baseline to change, or reset and be recalculated, or silence further notifications. In other cases, the command instruction may cause the agent processor 140 to retrieve additional detail from a dashboard interface regarding an indication, and optionally generate a natural language summary for transmission in a further message or notification.

Monitoring processor 130 can be configured to generate a dashboard interface for display to a user via user device 150. The dashboard interface presents the plurality of metrics and threshold baselines in graphical user interface.

Further, another aspect that can assist in identifying anomalous activity is the grouping disparate sources of information in a related view of the dashboard interface provided by the monitoring processor 130 and/or user device 150. For example, a single data source such as credit card transactions may increase or decrease regularly without any discernible cause, or cause for concern. However, the dashboard may present event volume data in conjunction with other data, e.g., fraud tagging from customers or support center volumes. Accordingly, the combination of both signals may serve as a better indicator of potentially anomalous activity, in a manner that the individual signals would not. Moreover, presenting both signals in a single view assists with initial triage and diagnosis. The dashboard further permits a user to drill down into more detailed data by selecting individual signals.

Accordingly, the provided system facilitates real-time monitoring and alerting that can reduce false positives and false negatives, and also relieves users of the burden of having to manually identify anomalous activity.

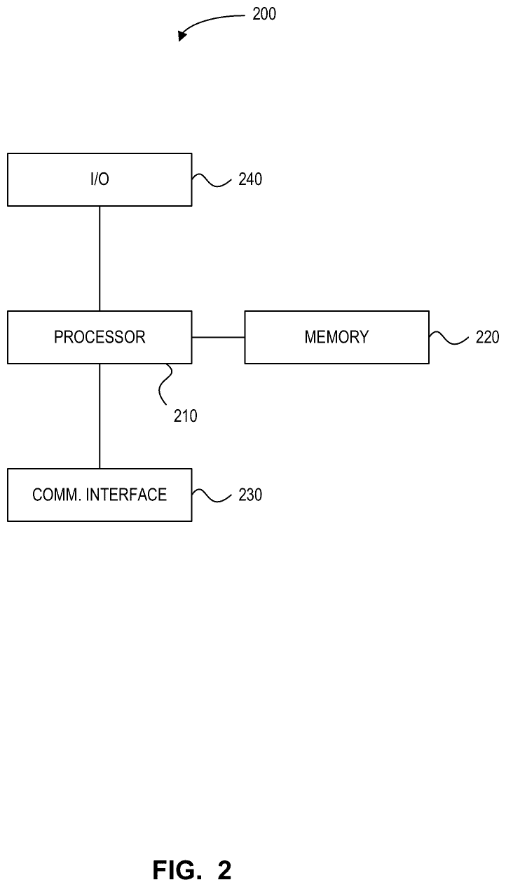

Referring now to FIG. 2, there is illustrated a simplified block diagram of a computer in accordance with at least some embodiments. Computer 200 is an example implementation of a computer such as a data source 110, a microservice processor 120, a monitoring processor 130, an agent processor 140, a user device 150 and a message microservice 160. Computer 200 has at least one processor 210 operatively coupled to at least one memory 220, at least one communications interface 230, at least one input/output device 240.

The at least one memory 220 includes a volatile memory that stores instructions executed or executable by processor 210, and input and output data used or generated during execution of the instructions. Memory 220 may also include non-volatile memory used to store input and/or output data—e.g., within a database—along with program code containing executable instructions.

Processor 210 may transmit or receive data via communications interface 230 and may also transmit or receive data via any additional input/output device 240 as appropriate.

In some implementations, computer 200 may be party of a distributed computing system, or cloud computing system.

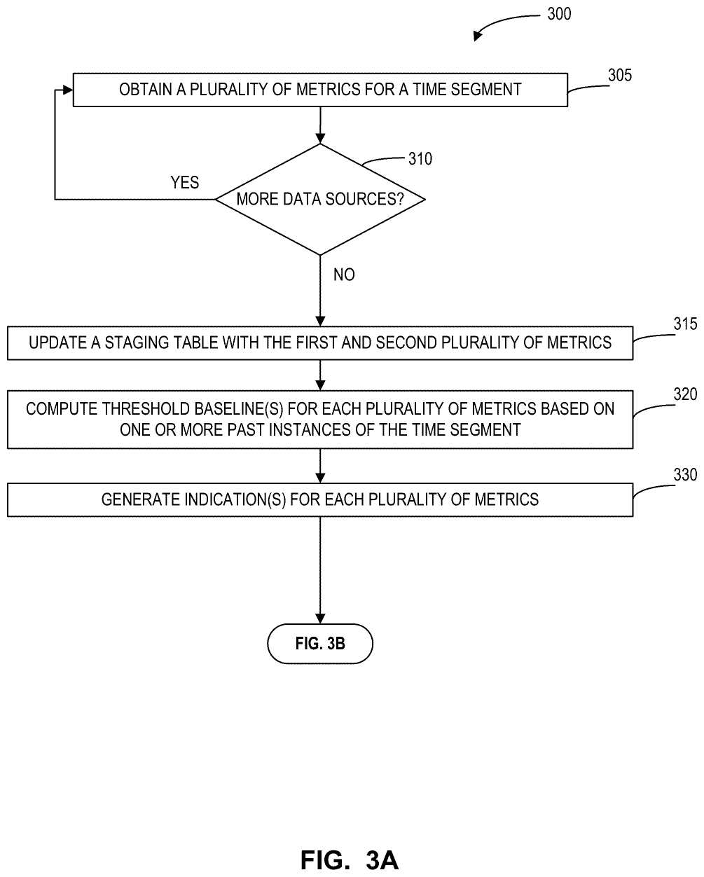

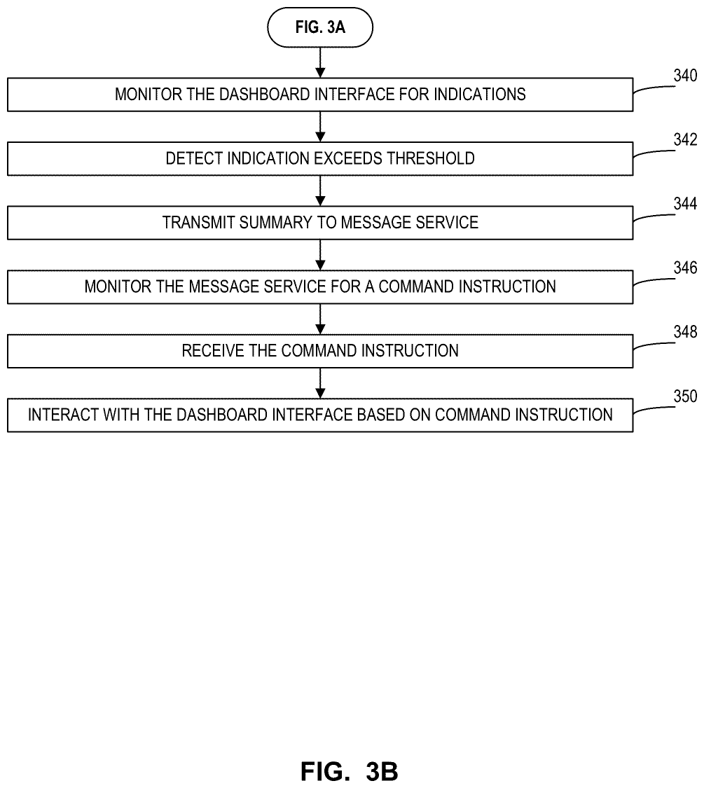

Referring now to FIGS. 3A and 3B, there is shown a flowchart of an example process 300 for identifying anomalies in transaction activity data a plurality of data sources having at least a first data source and a second data source. In some implementations, one or more process blocks of FIGS. 3A and 3B may be performed by one or more of the elements of system 100, such as monitoring processor 130.

Process 300 may include additional implementations, such as any single implementation or any combination of implementations described below and/or in connection with one or more other processes described elsewhere herein.

Process 300 begins at 305 with obtaining a first plurality of metrics for a time segment, for example from a first data source or from a first microservice processor that has been configured to process data from the first data source to form the first plurality of metrics for the time segment. At 310, the processor determines whether there are additional data sources, in which case the processor returns to 305 to obtain further metrics from the additional data sources or respective microservice processors that have processed raw data into the corresponding plurality of metrics. For example, when there is a second data source, a second plurality of metrics for the same time segment is obtained, which may be from a second data source or from a second microservice processor. As described elsewhere herein, additional pluralities of metrics may also be obtained from additional data sources or microservice processors. Each of the microservice processors may operate in a pipelined process for the time segment by querying the respective data source for data associated with the time segment

Once there are no further metrics to retrieve, or in parallel with the retrieval, at 315, the processor updates a staging table or staging tables with each of the plurality of metrics that have been retrieved. For example, the processor may update a staging table or tables with the first and second plurality of metrics.

At 320, the processor computes threshold baselines for each of the plurality of metrics that have been retrieved for the one or more past instances of the time segment, as described elsewhere herein. For example, if two pluralities of metrics have been retrieved, then the processor computes a first threshold baseline for the first plurality of metrics based on one or more past instances of the time segment, and a second threshold baseline for the second plurality of metrics based on the one or more past instances of the time segment.

At 330, the processor generates indications for each of the pluralities of metrics, which may be transmitted for display in a dashboard interface as described elsewhere herein. For example, if the processor determines that a metric exceeds its respective threshold baseline, the indication for that metric may indicate this. This process may be repeated for each of the plurality of metrics that have been retrieved. Each additional indication may, in some cases, be displayed proximally with a first or further indication. In some cases, a connection indicator may be displayed between the first and second indication.

In some cases, the indication may be a notification that is sent to a user device, or to a message service.

Optionally, at 340, a processor, which may be an agent processor different from a monitoring processor, may monitor the dashboard interface for indications (e.g., that a given plurality of metrics exceeds its threshold baseline). When the processor detects at 342 that the given plurality of metrics exceeds its threshold baseline, the processor may generate a summary of the respective indication, which may be a natural language summary, and transmit the summary to a message service at 344.

At 346, the processor may further monitor the message service for a command instruction and, in response to receipt of the command instruction at 348, interact with the dashboard interface based on the command instruction at 350. For example, the interaction may include retrieving additional detail from the dashboard interface regarding the indication that was the subject of the summary sent at 344. This process may be repeated as and when new indications are generated.

Although FIGS. 3A and 3B show example blocks of process 300, in some implementations, process 300 may include additional blocks, fewer blocks, different blocks, or differently arranged blocks than those depicted in FIGS. 3A and 3B. Additionally, or alternatively, two or more of the blocks of process 300 may be performed in parallel.

Various systems or processes have been described to provide examples of embodiments of the claimed subject matter. No such example embodiment described limits any claim and any claim may cover processes or systems that differ from those described. The claims are not limited to systems or processes having all the features of any one system or process described above or to features common to multiple or all the systems or processes described above. It is possible that a system or process described above is not an embodiment of any exclusive right granted by issuance of this patent application. Any subject matter described above and for which an exclusive right is not granted by issuance of this patent application may be the subject matter of another protective instrument, for example, a continuing patent application, and the applicants, inventors or owners do not intend to abandon, disclaim or dedicate to the public any such subject matter by its disclosure in this document.

For simplicity and clarity of illustration, reference numerals may be repeated among the figures to indicate corresponding or analogous elements. In addition, numerous specific details are set forth to provide a thorough understanding of the subject matter described herein. However, it will be understood by those of ordinary skill in the art that the subject matter described herein may be practiced without these specific details. In other instances, well-known methods, procedures, and components have not been described in detail so as not to obscure the subject matter described herein.

The terms “coupled” or “coupling” as used herein can have several different meanings depending in the context in which these terms are used. For example, the terms coupled or coupling can have a mechanical, electrical or communicative connotation. For example, as used herein, the terms coupled or coupling can indicate that two elements or devices are directly connected to one another or connected to one another through one or more intermediate elements or devices via an electrical element, electrical signal, or a mechanical element depending on the particular context. Furthermore, the term “operatively coupled” may be used to indicate that an element or device can electrically, optically, or wirelessly send data to another element or device as well as receive data from another element or device.

As used herein, the wording “and/or” is intended to represent an inclusive-or. That is, “X and/or Y” is intended to mean X or Y or both, for example. As a further example, “X, Y, and/or Z” is intended to mean X or Y or Z or any combination thereof.

Terms of degree such as “substantially”, “about”, and “approximately” as used herein mean a reasonable amount of deviation of the modified term such that the result is not significantly changed. These terms of degree may also be construed as including a deviation of the modified term if this deviation would not negate the meaning of the term it modifies.

Any recitation of numerical ranges by endpoints herein includes all numbers and fractions subsumed within that range (e.g., 1 to 5 includes 1, 1.5, 2, 2.75, 3, 3.90, 4, and 5). It is also to be understood that all numbers and fractions thereof are presumed to be modified by the term “about” which means a variation of up to a certain amount of the number to which reference is being made if the result is not significantly changed.

Some elements herein may be identified by a part number, which is composed of a base number followed by an alphabetical or subscript-numerical suffix (e.g. 112a, or 1121). All elements with a common base number may be referred to collectively or generically using the base number without a suffix (e.g. 112).

The systems and methods described herein may be implemented as a combination of hardware or software. In some cases, the systems and methods described herein may be implemented, at least in part, by using one or more computer programs, executing on one or more programmable devices including at least one processing element, and a data storage element (including volatile and non-volatile memory and/or storage elements). These systems may also have at least one input device (e.g. a pushbutton keyboard, mouse, a touchscreen, and the like), and at least one output device (e.g. a display screen, a printer, a wireless radio, and the like) depending on the nature of the device. Further, in some examples, one or more of the systems and methods described herein may be implemented in or as part of a distributed or cloud-based computing system having multiple computing components distributed across a computing network. For example, the distributed or cloud-based computing system may correspond to a private distributed or cloud-based computing cluster that is associated with an organization. Additionally, or alternatively, the distributed or cloud-based computing system be a publicly accessible, distributed or cloud-based computing cluster, such as a computing cluster maintained by Microsoft Azure™, Amazon Web Services™, Google Cloud™, or another third-party provider. In some instances, the distributed computing components of the distributed or cloud-based computing system may be configured to implement one or more parallelized, fault-tolerant distributed computing and analytical processes, such as processes provisioned by an Apache Spark™ distributed, cluster-computing framework or a Databricks™ analytical platform. Further, and in addition to the CPUs described herein, the distributed computing components may also include one or more graphics processing units (GPUs) capable of processing thousands of operations (e.g., vector operations) in a single clock cycle, and additionally, or alternatively, one or more tensor processing units (TPUs) capable of processing hundreds of thousands of operations (e.g., matrix operations) in a single clock cycle.

Some elements that are used to implement at least part of the systems, methods, and devices described herein may be implemented via software that is written in a high-level procedural language such as object-oriented programming language. Accordingly, the program code may be written in any suitable programming language such as Python or Java, for example. Alternatively, or in addition thereto, some of these elements implemented via software may be written in assembly language, machine language or firmware as needed. In either case, the language may be a compiled or interpreted language.

At least some of these software programs may be stored on a storage media (e.g., a computer readable medium such as, but not limited to, read-only memory, magnetic disk, optical disc) or a device that is readable by a general or special purpose programmable device. The software program code, when read by the programmable device, configures the programmable device to operate in a new, specific, and predefined manner to perform at least one of the methods described herein.

Furthermore, at least some of the programs associated with the systems and methods described herein may be capable of being distributed in a computer program product including a computer readable medium that bears computer usable instructions for one or more processors. The medium may be provided in various forms, including non-transitory forms such as, but not limited to, one or more diskettes, compact disks, tapes, chips, and magnetic and electronic storage. Alternatively, the medium may be transitory in nature such as, but not limited to, wire-line transmissions, satellite transmissions, internet transmissions (e.g., downloads), media, digital and analog signals, and the like. The computer usable instructions may also be in various formats, including compiled and non-compiled code.

While the above description provides examples of one or more processes or systems, it will be appreciated that other processes or systems may be within the scope of the accompanying claims.

To the extent any amendments, characterizations, or other assertions previously made (in this or in any related patent applications or patents, including any parent, sibling, or child) with respect to any art, prior or otherwise, could be construed as a disclaimer of any subject matter supported by the present disclosure of this application, Applicant hereby rescinds and retracts such disclaimer. Applicant also respectfully submits that any prior art previously considered in any related patent applications or patents, including any parent, sibling, or child, may need to be revisited.

What is claimed is:

1. A system for identifying anomalies in event activity data, the system comprising:
a plurality of data sources comprising at least a first data source and a second data source;
a first microservice processor configured to process the first data source to form a first plurality of metrics for a time segment;
a second microservice processor configured to process the second data source to form a second plurality of metrics for the time segment;
a monitoring processor configured to:
obtain the first plurality of metrics for the time segment from the first microservice processor;
obtain the second plurality of metrics for the time segment from the second microservice processor;
update a staging table with the first and second plurality of metrics;
compute a first threshold baseline for the first plurality of metrics based on one or more past instances of the time segment;
compute a second threshold baseline for the second plurality of metrics based on the one or more past instances of the time segment;
display a first indication of the first plurality of metrics in a dashboard, wherein the first indication is indicative that the first plurality of metrics exceeds the first threshold baseline; and
display a second indication of the second plurality of metrics in the dashboard.

2. The system of claim 1, wherein the second indication is indicative that second first plurality of metrics exceeds the second threshold baseline, and wherein the second indication is displayed proximally with the first indication.

3. The system of claim 2, wherein the first and second indication comprise a connection indicator between the first and second indication.

4. The system of claim 1, further comprising:
at least one additional microservice processor, each microservice processor configured to process a respective data source to form a respective plurality of metrics for the time segment,
wherein the monitoring processor is further configured to, for each respective one of the at least one additional microservice processor:
obtain the respective plurality of metrics for the time segment;
update the staging table with the respective plurality of metrics;
compute a respective threshold baseline for the respective plurality of metrics based on the one or more past instances of the time segment; and
display a respective indication of the respective plurality of metrics in the dashboard.

5. The system of claim 1, further comprising an agent processor, the agent processor configured to:
monitor the dashboard for the first indication;
when the first indication is indicative that the first plurality of metrics exceeds the first threshold baseline, generate a natural language summary of the first indication; and
transmit the natural language summary of the first indication to a message service.

6. The system of claim 5, wherein the agent processor is further configured to monitor the message service for a command instruction and, in response to receipt of the command instruction, interact with the dashboard.

7. The system of claim 6, wherein the interacting with the dashboard interface comprises retrieving additional detail from the dashboard interface regarding the first indication.

8. The system of claim 1, wherein the first microservice processor processes the first data source in a pipelined process for the time segment by querying the first data source for data associated with the time segment.

9. A method for identifying anomalies in event activity data from a plurality of data sources having at least a first data source and a second data source, the method comprising a monitoring processor:
obtaining a first plurality of metrics for a time segment;
obtaining a second plurality of metrics for the time segment;
updating a staging table with the first and second plurality of metrics;
computing a first threshold baseline for the first plurality of metrics based on one or more past instances of the time segment;
computing a second threshold baseline for the second plurality of metrics based on the one or more past instances of the time segment;
displaying a first indication of the first plurality of metrics in a dashboard, wherein the first indication is indicative that the first plurality of metrics exceeds the first threshold baseline; and
displaying a second indication of the second plurality of metrics in the dashboard.

10. The method of claim 9, wherein the first plurality of metrics is obtained from a first microservice processor configured to process the first data source to form the first plurality of metrics for the time segment.

11. The method of claim 10, wherein the second plurality of metrics is obtained from a second microservice processor configured to process the second data source to form the second plurality of metrics for the time segment.

12. The method of claim 9, wherein the second indication is indicative that second first plurality of metrics exceeds the second threshold baseline, and wherein the second indication is displayed proximally with the first indication.

13. The method of claim 9, wherein the first and second indication comprise a connection indicator between the first and second indication.

14. The method of claim 9, further comprising:
at least one additional microservice processor processing a respective data source to form a respective plurality of metrics for the time segment.

15. The method of claim 14, further comprising the monitoring processor, for each respective one of the at least one additional microservice processor:
obtaining the respective plurality of metrics for the time segment;
updating the staging table with the respective plurality of metrics;
computing a respective threshold baseline for the respective plurality of metrics based on the one or more past instances of the time segment; and
displaying a respective indication of the respective plurality of metrics in the dashboard.

16. The method of claim 9, further comprising an agent processor:
monitoring the dashboard for the first indication;
when the first indication is indicative that the first plurality of metrics exceeds the first threshold baseline, generating a natural language summary of the first indication; and
transmitting the natural language summary of the first indication to a message service.

17. The method of claim 16, further comprising the agent processor monitoring the message service for a command instruction and, in response to receipt of the command instruction, interacting with the dashboard interface.

18. The method of claim 17, wherein the interacting with the dashboard interface comprises retrieving additional detail from the dashboard interface regarding the first indication.

19. The method of claim 10, wherein the first microservice processor processes the first data source in a pipelined process for the time segment by querying the first data source for data associated with the time segment.

20. A non-transitory computer readable medium storing computer executable instructions which, when executed by at least one computer processor, cause the at least one computer processor to carry out a method for identifying anomalies in transaction activity data a plurality of data sources having at least a first data source and a second data source, the method comprising:
obtaining a first plurality of metrics for a time segment;
obtaining a second plurality of metrics for the time segment;
updating a staging table with the first and second plurality of metrics;
computing a first threshold baseline for the first plurality of metrics based on one or more past instances of the time segment;
computing a second threshold baseline for the second plurality of metrics based on the one or more past instances of the time segment;
displaying a first indication of the first plurality of metrics in a dashboard, wherein the first indication is indicative that the first plurality of metrics exceeds the first threshold baseline; and
displaying a second indication of the second plurality of metrics in the dashboard.
